(19) United States
(12) Patent Application Publication
(10) Pub. No.: US 2026/0045849 A1
(43) Pub. Date: Feb. 12, 2026

(54) VIBRATION ABSORBER FOR VEHICLE ELECTRIC GENERATOR

(71) Applicant: FCA US LLC, Auburn Hills, MI (US)

(72) Inventors: Serge F. Fadavi, Poissy (FR); Dhafar Al-Ani, Auburn Hills, MI (US)

(21) Appl. No.: 18/800,483

(22) Filed: Aug. 12, 2024

(51) Int. Cl. H02K 5/24; F16F 15/14

(52) U.S. Cl. CPC H02K 5/24; F16F 15/1407

(57) ABSTRACT

An electric motor/generator configured to couple to an output of an internal combustion engine and generate power for an electrified vehicle includes a stator assembly, a rotor assembly, and a centrifugal pendulum vibration absorber (CPVA) assembly integrated into the rotor assembly and configured to absorb one or more vibrations and/or noise orders over an entire speed range of the electric motor/generator.

### FIELD

The present application relates generally to electric vehicles and, more particularly, to an electric vehicle generator with centrifugal pendulum vibration absorbers.

### BACKGROUND

Some electrified vehicles (EVs), such as range extended electrical vehicles (REEVs) include an electrical generator coupled to an internal combustion engine. However, the dynamics of the generator are highly impacted by order vibrations, order noise, and related torque irregularities (torque ripple) generated by the EV. This may include a high level of vibrational orders at bearing seats and/or powertrain mounts, order noise (whine) radiated from the generator and engine housings, and torsional excitation (torque ripple) on the driveline itself transmitted through the transmission system and down the wheels. Accordingly, while such electric vehicle systems do work for their intended purpose, there is a desire for improvement in the relevant art.

### SUMMARY

In accordance with one example aspect of the invention, an electric motor/generator configured to couple to an output of an internal combustion engine and generate power for an electrified vehicle is provided. In one exemplary implementation, the motor/generator includes a stator assembly, a rotor assembly, and a centrifugal pendulum vibration absorber (CPVA) assembly integrated into the rotor assembly and configured to absorb one or more vibrations and/or noise orders over an entire speed range of the electric motor/generator.

In addition to the foregoing, the described electric motor/generator may include one or more of the following features: wherein the CPVA assembly includes a plurality of pendular mass dampers; wherein each pendular mass damper includes a mass disposed within a slot; wherein the each pendular mass damper is a spherical pendulum; wherein the each pendular mass damper is a roller pendulum; wherein the each pendular mass damper is a laminated bifilar pendulum; wherein the rotor assembly includes opposed first and second end plates, wherein the CVPA assembly is integrated into the first end plate; wherein the first end plate is disposed on a side of the rotor assembly closest to the internal combustion engine; and wherein the CPVA assembly includes a plurality of pendular mass dampers arranged circumferentially about an outer perimeter of the first end plate.

In accordance with another example aspect of the invention, an electric vehicle is provided. In one exemplary implementation, the electric vehicle includes an electric drive module (EDM) configured to drive the electric vehicle, a high voltage battery system configured to power the EDM, and an internal combustion engine. A motor/generator is coupled to an output of the internal combustion engine and configured to selectively generate power to charge the high voltage battery system and/or provide power directly to the EDM. A centrifugal pendulum vibration absorber (CPVA) assembly is integrated into the motor/generator and configured to absorb one or more vibrations and/or noise orders over an entire speed range of the motor/generator.

In addition to the foregoing, the described electric vehicle may include one or more of the following features: wherein the motor/generator includes a stator assembly and a rotor assembly, wherein the CPVA assembly is integrated into the rotor assembly; wherein the CPVA assembly includes a plurality of pendular mass dampers; wherein each pendular mass damper includes a mass disposed within a slot; wherein the each pendular mass damper is a spherical pendulum; wherein the each pendular mass damper is a roller pendulum; and wherein the each pendular mass damper is a laminated bifilar pendulum.

In addition to the foregoing, the described electric vehicle may include one or more of the following features: wherein the rotor assembly includes opposed first and second end plates, wherein the CVPA assembly is integrated into the first end plate; wherein the first end plate is disposed on a side of the rotor assembly closest to the internal combustion engine; and wherein the CPVA assembly includes a plurality of pendular mass dampers arranged circumferentially about an outer perimeter of the first end plate.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example hybrid electric vehicle (HEV) powertrain, in accordance with the principles of the present application;

FIG. 2 is a perspective view of an example rotor assembly of an electric motor/generator of the HEV powertrain shown in FIG. 1, in accordance with the principles of the present application; and

FIG. 3 illustrates example pendular mass dampers that may be integrated into the rotor assembly shown in FIG. 2, in accordance with the principles of the present application.

### DETAILED DESCRIPTION

As previously described, some electric vehicles (EVs) include an electrical generator, which may be impacted by order vibrations, order noise, and their related torque irregularities coming from an internal combustion engine (combustion orders) and the electrical generator (e-magnetic orders). Accordingly, described herein are systems and methods for absorbing vibrations at the electrical generator. In one example, the electrical generator includes a centrifugal pendulum vibration absorber (CPVA) assembly, also referred to as an order tuned absorber, which includes a plurality of pendular mass dampers (pendulums) distributed around the circumference of a rotating structure of the generator. For example, a predetermined number of pendulums are positioned on the generator rotor endplate on the side of the connection with the engine. Advantageously, the CVPA assembly can be tuned to target single or several vibrational orders all over the generator speed range, not only at a speed or narrow frequency band like complex mass-spring systems.

In general, if the structure is excited at a frequency f ₑ, pendular mass dampers are tuned to the same frequency. A pendulum of the CPVA is moving in the centrifugal acceleration field of the rotor. A stiffness is brought which is proportional to the centrifugal acceleration \dot{θ}(t)². The pendulum natural frequency is proportional to rotational speed \dot{θ}(t). The proportionality coefficient is controlled through the pendulum trajectory. In this way, the pendulums are tuned for an order and can lower the desired vibrations and/or noise order levels independently from the rotational velocity \dot{θ}(t). Therefore, a specific vibration and/or noise order (or several orders) can be lowered for all speed ranges, not only for a single speed or a narrow frequency band.

The CPVA assembly is configured to improve the dynamics and NVH of the coupled internal combustion engine and electrical generator system. The CPVA assembly is configured to reduce order noise coming from both the generator and the engine including their related torque ripples. The tuning of pendular mass dampers is done through an accurate choice of their masses and their trajectories (paths) for a single or several orders. Positioning of a predetermined number of pendulums on the electrical generator rotor endplate on the side of the connection to the engine will maximize the CPVA dampening effect for both generator and engine vibration and/or noise orders.

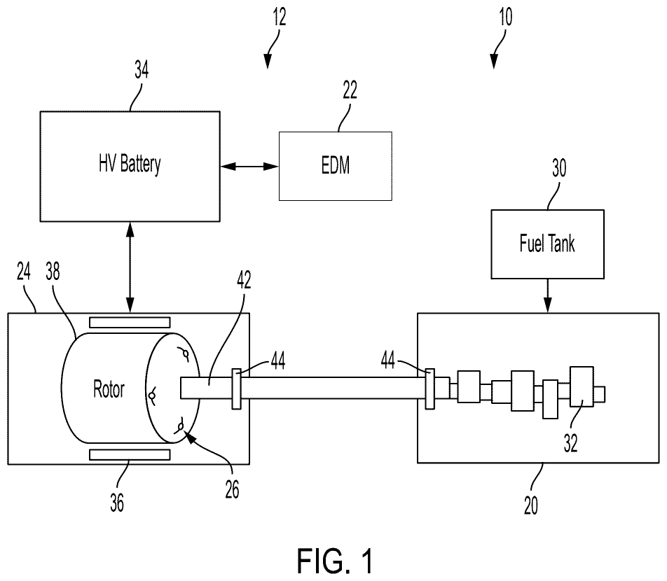

With initial reference to FIG. 1, a schematic diagram of an example hybrid electric vehicle (HEV) 10 is illustrating having a hybrid powertrain 12 according to example implementations of the disclosure. In one example, the HEV 10 is a range-extended EV (REEV), also referred to as a range-extended paradigm breaker (REPB). In the illustrated example, the powertrain 12 generally includes an internal combustion engine 20, one or more electric drive modules (EDMs) 22, and a motor/generator 24. As described herein in more detail, the electric vehicle 10 advantageously provides a centrifugal pendulum vibration absorber (CPVA) assembly 26 tuned to target single or several vibrations and/or noise orders over the entire rotational speed range of the motor/generator 24.

The engine 20 receives fuel (e.g., gasoline) from a fuel tank 30 and combusts a mixture of air and fuel within cylinders to drive pistons that rotatably turn a crankshaft 32. The generated torque drives the motor/generator 24 to produce electricity to charge a high voltage (HV) battery 34 or power the EDMs 22 directly. In other operations, the motor/generator 24 is powered by the HV battery 34 to control engine stop/start operations. The EDM 22, which includes an electric traction motor, is powered by the HV battery 34 and/or the motor/generator 24 to selectively provide drive torque to one or more vehicle axles (not shown).

The EDM 22 generally includes an electric machine (not shown), such as an electric traction motor, which can operate reversibly as a motor or a generator. The electric machine is electrically coupled to HV battery 34 via a power inverter module (PIM) (not shown), and is configured to drive vehicle wheels through a gearbox and axle shafts (not shown).

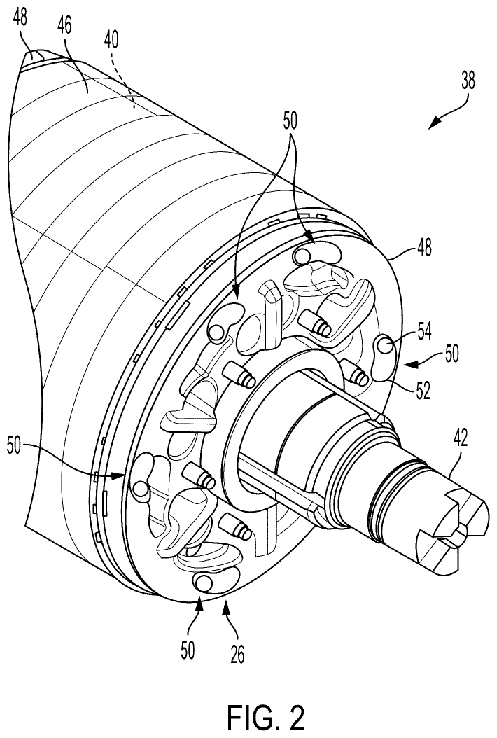

With additional reference to FIG. 2, in the example embodiment, the motor/generator 24 generally includes a stator assembly 36 operably associated with a rotor assembly 38 having a plurality of permanent magnets 40. In general, when operating as a motor, the stator assembly 36 receives electrical power to produce a magnetic field, which interacts with a magnetic field of the rotor assembly 38 to produce mechanical power to a shaft 42 rotatably supported by one or more bearings 44. When operating as a generator, the shaft 42 is rotated by the engine crankshaft 32, and the magnetic field of the rotor assembly 38 interacts with the magnetic field of the stator assembly 36 to produce electrical power, which is then supplied to the HV battery 34 (or directly to EDM 22).

In one example, the rotor assembly 38 is formed from a plurality of individual circular rotor laminations 46 disposed between a pair of end plates 48. The rotor laminations 46 and end plates 48 are coupled together, for example, by gluing, interlocking, welding, or other suitable joining technique. As shown, the end plate 48 on the rotor side connecting to the engine 20 includes the CPVA assembly 26. However, it will be appreciated that the opposite end plate 48 may alternatively or additionally include the CPVA assembly 26.

With continued reference to FIG. 2, in the example embodiment, the CPVA assembly 26 includes a plurality pendular mass dampers (pendulums) 50, each comprising an aperture or slot 52 that receives a mass 54, such as a roller or pin, which is movable within the slot 52. The slot 52 is formed in the end plate 48 and the shape of each slot 52 is designed/tuned to provide a path for the mass 54 to dampen one or more vibration and/or noise orders for the particular powertrain 12 during operation thereof. In the illustrated example, the pendulums 50 are circumferentially and evenly spaced about the outer perimeter/diameter of end plate 48. However, it will be appreciated that pendulums 50 may be located in any suitable location, arrangement, spacing, etc. on the end plate 48.

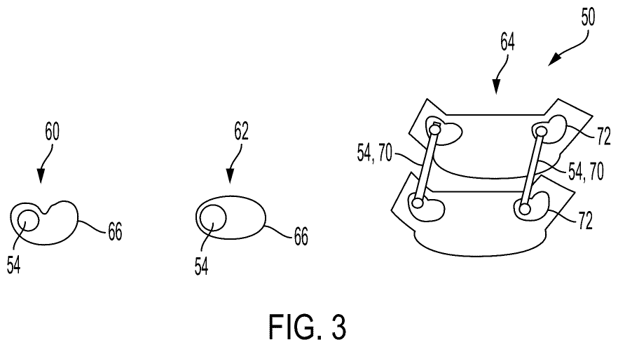

FIG. 3 illustrates example types of pendulums 50, including a spherical pendulum 60, a roller pendulum 62, and a laminated bifilar pendulum 64. As shown, the spherical pendulum 60 includes a generally arc shaped slot 66, roller pendulum 62 includes a generally oval or ellipse shaped slot 68, and laminated bifilar pendulum 64 includes rod or pin-like masses 70 extending between a pair of slots 72.

Described herein are systems and methods for reducing vibrations in an electrical generator and internal combustion engine system. A centrifugal pendulum vibration absorber (CVPA) assembly includes pendulums positioned on the generator endplate tuned to target a single or several vibrations and/or noise orders all over the generator speed range. The CVPA assembly is a relatively simple, passive device and is not costly compared to more complex and less efficient mass spring systems, costly bearing layouts, and active dampener devices. The CVPA assembly advantageously reduces bearing loads and reduces the number of required bearings.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric motor/generator configured to couple to an output of an internal combustion engine and generate power for an electrified vehicle, the motor/generator comprising:
a stator assembly;
a rotor assembly; and
a centrifugal pendulum vibration absorber (CPVA) assembly integrated into the rotor assembly and configured to absorb one or more vibrations and/or noise orders over an entire speed range of the electric motor/generator.

2. The electric motor/generator of claim 1, wherein the CPVA assembly includes a plurality of pendular mass dampers.

3. The electric motor/generator of claim 2, wherein each pendular mass damper includes a mass disposed within a slot.

4. The electric motor/generator of claim 3, wherein the each pendular mass damper is a spherical pendulum.

5. The electric motor/generator of claim 3, wherein the each pendular mass damper is a roller pendulum.

6. The electric motor/generator of claim 3, wherein the each pendular mass damper is a laminated bifilar pendulum.

7. The electric motor/generator of claim 1, wherein the rotor assembly includes opposed first and second end plates, wherein the CVPA assembly is integrated into the first end plate.

8. The electric motor/generator of claim 7, wherein the first end plate is disposed on a side of the rotor assembly closest to the internal combustion engine.

9. The electric motor/generator of claim 7, wherein the CPVA assembly includes a plurality of pendular mass dampers arranged circumferentially about an outer perimeter of the first end plate.

10. An electric vehicle, comprising:
an electric drive module (EDM) configured to drive the electric vehicle;
a high voltage battery system configured to power the EDM;
an internal combustion engine;
a motor/generator coupled to an output of the internal combustion engine and configured to selectively generate power to charge the high voltage battery system and/or provide power directly to the EDM; and
a centrifugal pendulum vibration absorber (CPVA) assembly integrated into the motor/generator and configured to absorb one or more vibrations and/or noise orders over an entire speed range of the motor/generator.

11. The electric vehicle of claim 10, wherein the motor/generator comprises:
a stator assembly; and
a rotor assembly,
wherein the CPVA assembly is integrated into the rotor assembly.

12. The electric vehicle of claim 11, wherein the CPVA assembly includes a plurality of pendular mass dampers.

13. The electric vehicle of claim 12, wherein each pendular mass damper includes a mass disposed within a slot.

14. The electric vehicle of claim 13, wherein the each pendular mass damper is a spherical pendulum.

15. The electric vehicle of claim 13, wherein the each pendular mass damper is a roller pendulum.

16. The electric vehicle of claim 13, wherein the each pendular mass damper is a laminated bifilar pendulum.

17. The electric vehicle of claim 11, wherein the rotor assembly includes opposed first and second end plates, wherein the CVPA assembly is integrated into the first end plate.

18. The electric vehicle of claim 17, wherein the first end plate is disposed on a side of the rotor assembly closest to the internal combustion engine.

19. The electric vehicle of claim 17, wherein the CPVA assembly includes a plurality of pendular mass dampers arranged circumferentially about an outer perimeter of the first end plate.
